(19) United States
(12) Patent Application Publication
(10) Pub. No.: US 2022/0057017 A1
(43) Pub. Date: Feb. 24, 2022

(54) EXPANDABLE BARRIER ACTUATED VALVE

(71) Applicant: Nikon Corporation, Tokyo (JP)

(72) Inventors: Alex Ka Tim Poon, San Ramon, CA (US); Michael Birk Binnard, Belmont, CA (US); Gaurav Keswani, Foster City, CA (US)

(21) Appl. No.: 17/405,793

(22) Filed: Aug. 18, 2021

Related U.S. Application Data
(60) Provisional application No. 63/068,447, filed on Aug. 21, 2020.

(51) Int. Cl. F16K 99/00; F16K 51/02; F16K 3/14; F16K 3/18

(52) U.S. Cl. CPC F16K 99/0011; F16K 51/02; F16K 3/18; F16K 99/0042; F16K 3/14

(57) ABSTRACT

A valve (10) for selectively opening and closing a flow passageway (12) includes (i) a valve body (14) that defines a body passageway (16); (ii) a first valve surface (18) that defines a first valve opening (18A); (iii) an expandable barrier (22); and (iv) an actuation system (24). The expandable barrier (22) is movable in the body passageway (16) between an open configuration (30) in which the barrier (22) is retracted and does not engage the first valve surface (18); and a closed configuration (28) in which the barrier (22) is expanded, engages the first valve surface (18), and blocks the first valve opening (18A). The actuation system (24) selectively moves the barrier (22) between the configurations (28) (30).

### RELATED APPLICATION

This application claims priority on U.S. Provisional Application No: 63/068,447 filed on Aug. 21, 2020, and entitled “EXPANDABLE BARRIER ACTUATED VALVE”. As far as permitted the contents of U.S. Provisional Application No: 63/068,447 are incorporated in their entirety herein by reference.

### BACKGROUND

Gate valves are used in many different fluid applications. A typical gate valve includes a valve body that defines a body passageway, and a gate that is selectively moved relative to the valve body (i) into the body passageway to block the path of the body passageway (and close the valve), and (ii) out of the body passageway to open the path of the body passageway (and open the valve).

Unfortunately, existing gate valves have a relatively high leak rate for ultra-high vacuum applications. Moreover, existing gate valves have a relatively large form factor.

### SUMMARY

The present implementation is directed to a valve for selectively opening and closing a flow passageway. The valve can include (i) a valve body that defines a body passageway; (ii) a first valve surface that defines a first valve opening; (iii) an expandable barrier; and (iv) an actuation system. The expandable barrier is movable in the body passageway between an open configuration in which the barrier is retracted and does not engage the first valve surface; and a closed configuration in which the barrier is expanded, engages the first valve surface, and blocks the first valve opening. The actuation system selectively moves the barrier between the configurations.

As provided herein, the valve is uniquely designed to have very little leakage in ultra-high vacuum applications. Moreover, the valve is designed to have a relatively small form factor.

In one implementation, the barrier can include a first expansion region and a first seal that is coupled to the first expansion region. In this implementation, in the open configuration, the first expansion region is retracted and the first seal is spaced apart from the first valve surface; and in the closed configuration, the first expansion region is expanded and the first seal engages the first valve surface to block the first valve opening.

Additionally, the valve body can include a second valve surface having a second valve opening. In this design, in the open configuration, the barrier does not engage the second valve surface; and in the closed configuration, the barrier engages the second valve surface and blocks the second valve opening.

Moreover, the barrier can include a second expansion region and a second seal that is coupled to the second expansion region. In this design, in the open configuration, the second expansion region is retracted and the second seal is spaced apart from the second valve surface; and in the closed configuration, the second expansion region is expanded and the second seal engages the second valve surface to block the second valve opening. Further, with this design, when the barrier is in the closed configuration, the first valve opening can be maintained at a first pressure and the second valve opening can be maintained at a second pressure that is different from the first pressure. Additionally, when the barrier is in the closed configuration, a volume between the seals can be maintained at an intermediate pressure that is greater than the first pressure and less than the second pressure.

In one implementation, the actuation system includes (i) an expansion actuator system that selectively directs a barrier fluid into the barrier to move the barrier to the closed configuration, and selectively removes the barrier fluid from the barrier to move the barrier to the open configuration; and (ii) a transverse actuator system that selectively moves the expandable barrier transversely to the first valve opening. The transverse actuator system can selectively move the expandable barrier between a first position in which the barrier is aligned with the first valve opening, and a second position in which the barrier is not aligned with the first valve opening.

As provided herein, the valve can be used as part of a number of different assemblies. For example, the assembly can include the valve, and an environmental controller that controls the pressure in the first valve opening. Further, the assembly can include an electron beam source that selectively directs an electron beam through the valve. With this design, the valve forms a portion of an electron beam column. Moreover, the assembly can be a metal, three dimensional printer that includes a powder bed that retains a powder, and that uses the electron beam to melt at least a portion of the powder on the powder bed to form a three dimensional object. Alternatively, the assembly can be a lithography system that includes a stage that retains a semiconductor wafer, and that uses the electron beam to transfer one or more images to the semiconductor wafer.

In another implementation, the valve includes: (i) a valve body that defines a body passageway, the valve body includes a first valve surface that defines a first valve opening, and a second valve surface that defines a second valve opening; (ii) an expandable barrier; and (iii) an actuation system that selectively moves the barrier. In this implementation, the expandable barrier that is movable in the body passageway with the actuation system between (i) a closed configuration in which the barrier is expanded, engages the first valve surface and second valve surface, and blocks the first valve opening and the second valve opening; (ii) an open configuration in which the barrier is retracted and does not engage the first valve surface and the second valve surface; and (iii) a withdrawn configuration in which the barrier is moved transversely away from the valve openings.

In still another implementation, a method for selectively opening and closing a flow passageway includes (i) providing a valve body that defines a body passageway, the valve body including a first valve surface that defines a first valve opening that is in fluid communication with the flow passageway; and (ii) selectively moving an expandable barrier in the body passageway between an open configuration in which the barrier is retracted and does not engage the first valve surface; and a closed configuration in which the barrier is expanded, engages the first valve surface, and blocks the first valve opening.

In another implementation, the valve includes: a valve body that defines a body passageway, the valve body includes a first valve surface that defines a first valve opening; a barrier that is arranged in the body passageway, the barrier switches configurations between an open configuration in which the barrier does not engage the first valve surface; and a closed configuration in which the barrier engages the first valve surface and blocks the first valve opening; and an actuation system that changes a state of the barrier between the configurations.

In this implementation, the barrier is expandable so that the barrier engages the first valve surface at the closed configuration.

The actuation system can include an expansion actuator system that changes the state of the barrier between an expanded state and a retracted state.

The actuator system sets the state of barrier to the expanded state in the closed configuration so that the barrier engages the first valve surface and blocks the first valve opening.

The barrier can be movable in the body passageway between a first position in the open configuration and a second position in the closed configuration.

The actuation system can include a transverse actuator system that changes a position of the barrier between the first position and the second position. The barrier can be expandable at the second position.

The actuation system moves the barrier between the first position and the second position in the retracted state, and the actuation system changes the state of barrier to the expanded state at the second position.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1 is a simplified perspective illustration of a valve;

FIG. 2 is a simplified, cut-away perspective illustration of the valve of FIG. 1 with an expandable barrier in a closed configuration;

FIG. 3 is a simplified, cut-away perspective illustration of the valve of FIG. 1 with the expandable barrier in an open configuration;

FIG. 4 is a simplified, cut-away perspective illustration of the valve of FIG. 1 with the expandable barrier in a withdrawn configuration;

FIG. 5 is a simplified, cut-away perspective illustration of the valve of FIG. 1 with the expandable barrier in an intermediate configuration;

FIG. 6 is a simplified perspective view of a portion of the valve of FIG. 1;

FIG. 7 is a simplified perspective view of a portion of the expandable barrier of FIGS. 2-5;

FIG. 8 is a simplified side view, in cut-away of another implementation of the valve;

FIG. 9 is a simplified side view of a first assembly that includes the valve;

FIG. 10 is a simplified side view of a second assembly that includes the valve;

FIG. 11 is a simplified side view of a third assembly that includes the valve; and

FIG. 12 is a simplified side view of a fourth assembly that includes the valve.

### DESCRIPTION

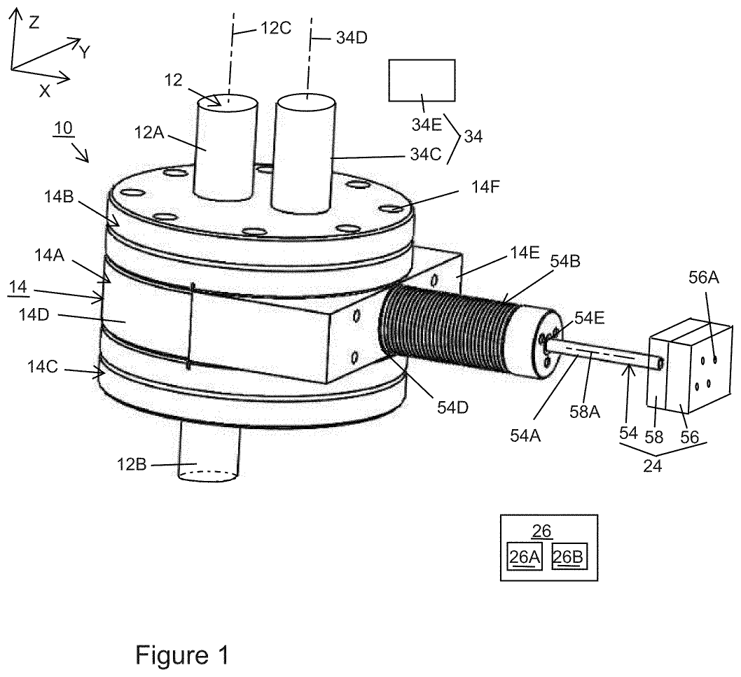

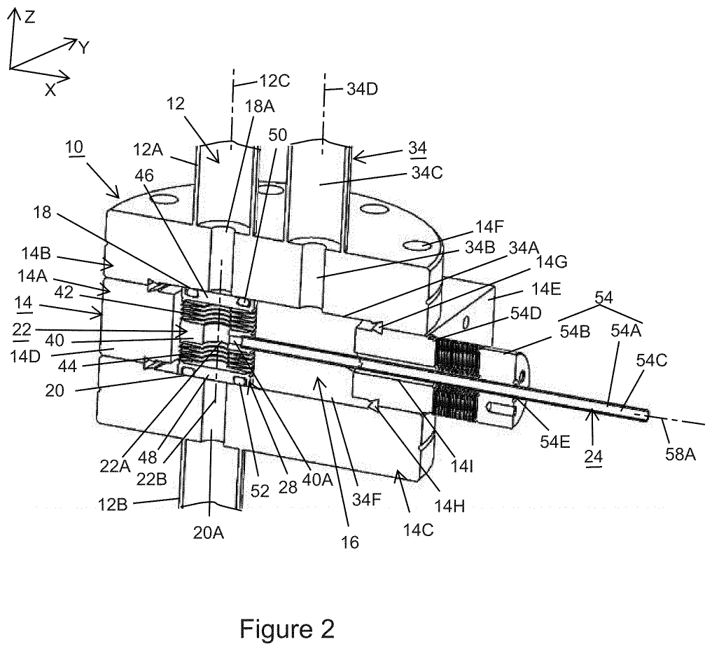

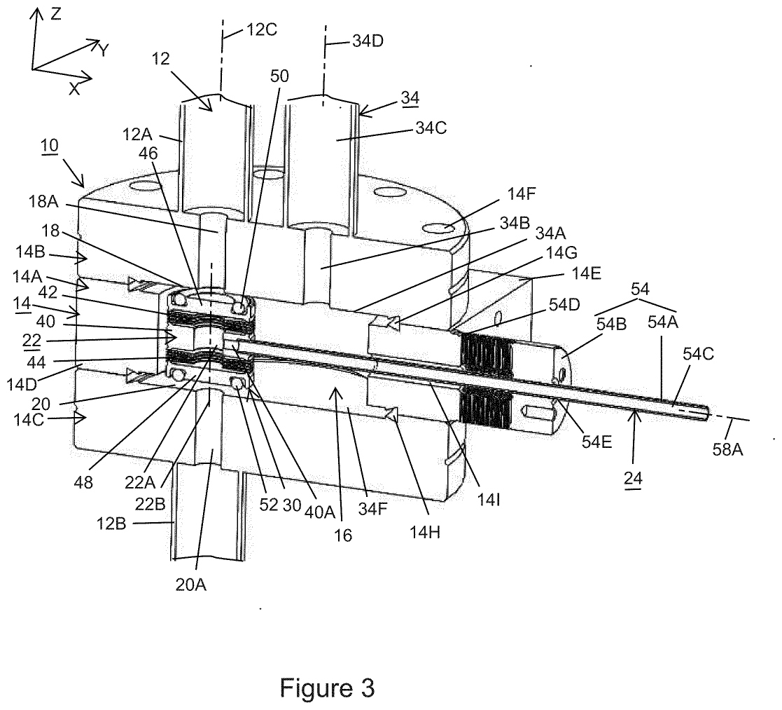

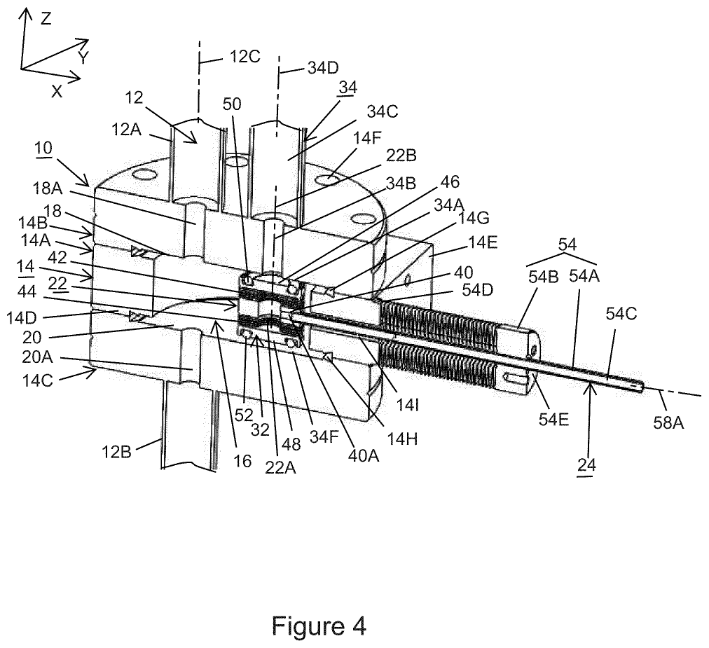

FIG. 1 is a simplified perspective illustration and FIGS. 2, 3, 4 and 5 are simplified cut-away perspective illustrations of a valve 10 for selectively controlling flow in a flow passageway 12. In one implementation, the valve 10 includes (i) a valve body 14 that defines a body passageway 16; (ii) a first valve surface 18 that defines a first valve opening 18A; (iii) a second valve surface 20 that defines a second valve opening 20A; (iv) an expandable barrier 22; (v) an actuation system 24 that selectively moves the expandable barrier 22; and (iv) a control system 26 (only illustrated in FIG. 1) that controls the actuation system 24 and the other components. The expandable barrier 22 is movable in the body passageway 16 between a closed configuration 28 (illustrated in FIG. 2) in which the barrier 22 engages the valve surfaces 18, 20 and blocks the valve openings 18A, 20A, and an open configuration 30 (illustrated in FIG. 3) in which the barrier 16 does not engage the valve surfaces 18, 20, and the valve openings 18A, 20A are open. Additionally, the barrier 22 can optionally be moved to a withdrawn configuration 32 (illustrated in FIG. 4) in which the barrier 22 is out of the path of the flow passageway 12.

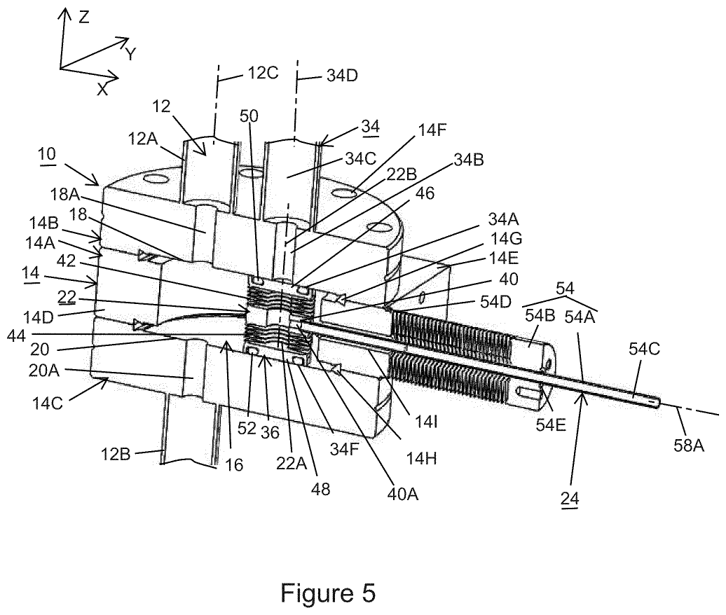

The design and/or positioning of these components can be varied pursuant to the teachings provided herein. Further, the valve 10 can be designed to include more or fewer components than described above. For example, the valve 10 can optionally include an intermediate pressure controller 34 as described below. In this implementation, the barrier 22 can additionally be moved to an intermediate configuration 36 (illustrated in FIG. 5) in which the intermediate pressure controller 34 is blocked.

It should be noted that the FIGS. 2-5 are similar cut-away views of the valve 10, and each Figure illustrates the barrier 22 at one of the four alternative configurations 28, 30, 32, 36.

As provided herein, the valve 10 is uniquely designed to have very little leakage in ultra-high vacuum applications. Moreover, the valve 10 is designed to have a relatively small form factor. The valve 10 can be used in any flow type application. However, the valve 10 is particularly useful for ultra-high vacuum or high vacuum or medium vacuum applications. Specific, non-exclusive applications for the valve 10 include a flight tube or column of an Electron beam system (e.g., lithography, metal three dimensional additive manufacturing), an extreme ultraviolet lithography system, Scanning Electron Microscope (SEM), or other system. In these examples, the valve 10 can be used to selectively isolate a vacuum environment from a non-vacuum environment, for example, during maintenance or a test.

Stated in another fashion, in certain implementations, the problem of providing a compact valve 10 that can support ultra-high vacuum requirements is solved by a valve that uses dual O-ring seals for sealing and one or more bellows for providing the necessary compression force on the O-ring seals.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, as used herein, movement with six degrees of freedom shall mean along and about the X, Y, and Z axes.

The flow passageway 12 can be selectively opened and closed by the valve 10. In the simplified implementation of FIGS. 1-5, the flow passageway 12 includes an upper, first conduit 12A, the body passageway 16 defined by the valve body 14, and the lower, second conduit 12B. In this implementation, each conduit 12A, 12B is a cylindrical tube. However, one or both conduits 12A, 12B can have a different configuration. Further, one or both conduits 12A, 12B can be connected to one or more components and/or chambers. In FIGS. 1-5, the conduits 12A, 12B (and the valve openings 18A, 20A) are aligned and spaced apart along a passageway axis 12C.

The valve body 14 defines the body passageway 16. Also, in this implementation, (i) the valve body 14 defines the valve surfaces 18, 20, (ii) the valve body 14 is rigid, and (iii) the valve body 14 includes a valve frame 14A, a first valve side 14B, and a second valve side 14C that cooperate to define the body passageway 16.

In one, non-exclusive implementation, the valve frame 14A is somewhat annular shaped and includes (i) a round arch shaped, first frame region 14D; and (ii) a square arch shaped, second frame region 14E that are fixed together (e.g. by a weld or other fashion). However, other configurations are possible.

The first valve side 14B is cylindrical disk shaped and is fixedly coupled to the top of the valve frame 14A. For example, one or more fasteners 14F (or other means) can be used to fixedly secure the first valve side 14B to the valve frame 14A. Moreover, a seal (not shown) can be positioned between the first valve side 14B and the valve frame 14A to seal this junction. For example, the seal can be a conflat type seal positioned in an upper groove 14G formed between the first valve side 14B and the valve frame 14A.

Additionally, the first valve side 14B can define the first valve surface 18 and the first valve opening 18A. In this implementation, the first valve surface 18 is a flat surface, and the first valve opening 18A is a cylindrical shaped opening through the first valve surface 18 and the first valve side 14B. Moreover, one end of the first conduit 12A can be fixedly secured (e.g. via weld or other method) to the first valve side 14B around the first valve opening 18A. With this design, the body passageway 16 is in fluid communication with first conduit 12A via the first valve opening 18A. As a non-exclusive example, (i) each valve opening 18A, 20A can have an inner diameter of between approximately two and one hundred and fifty millimeters; and/or (ii) each conduit 12A, 12B can have an inner diameter of between approximately two and one hundred millimeters. However, other dimensions (either larger or smaller than the previous range) for the valve openings 18A, 20A and conduits 12A, 12B are possible. As illustrated, each valve opening 18A, 20A is smaller than the inner diameter of the respective conduits 12A, 12B. Alternatively, for example, each valve opening 18A, 20A can be similar in size to the inner diameter of the respective conduits 12A, 12B.

Additionally, in the optional implementation with the intermediate pressure controller 34, the first valve side 14B can define an intermediate valve surface 34A and an intermediate valve opening 34B. In this implementation, the intermediate valve surface 34A is a flat surface, and the intermediate valve opening 34B is a cylindrical shaped opening through the intermediate valve surface 34A and the first valve side 14B. Moreover, one end of an intermediate conduit 34C is fixedly secured (e.g. via weld or other method) to the first valve side 14B around the intermediate valve opening 34B. In this implementation, the intermediate conduit 34C and the intermediate valve opening 34B extend along an intermediate axis 34D.

Additionally, the intermediate pressure controller 34 can include an intermediate pressure source 34E (illustrated in FIG. 1) that is in fluid communication with the intermediate conduit 34C. The design of the intermediate pressure source 34E can be varied according to the desired usage of the valve 10. For example, if the valve 10 is used for an ultra-high vacuum environment in the flow passageway 12, the intermediate pressure source 34E can be a mid-level vacuum source.

Somewhat similarly, the second valve side 14C is cylindrical disk shaped and is fixedly coupled to the bottom of the valve frame 14A. For example, one or more fasteners (not shown, or other means) can be used to fixedly secure the second valve side 14C to the valve frame 14A. Moreover, a seal (not shown) can be positioned between the second valve side 14C and the valve frame 14A to seal this junction. For example, the seal can be a conflat type seal positioned in a lower groove 14H formed between the second valve side 14C and the valve frame 14A. However, another type of seal can be utilized.

Additionally, the second valve side 14C can define the second valve surface 20 and the second valve opening 20A. In this implementation, the second valve surface 20 is a flat surface, and the second valve opening 20A is a cylindrical shaped opening through the second valve surface 20 and the second valve side 14C. Moreover, one end of the second conduit 12B can be fixedly secured (e.g. via weld or other method) to the second valve side 14C around the second valve opening 20A. With this design, the body passageway 16 is in fluid communication with second conduit 12B via the second valve opening 20A.

Additionally, in the optional implementation with the intermediate pressure controller 34, the second valve side 14C can define an engagement surface 34F without an opening. In this implementation, the engagement surface 34F is a flat surface.

With reference to FIGS. 2-5, the expandable barrier 22 is selectively movable by the actuator system 24 between the alternative configurations 28, 30, 32, 36 within the body passageway 16. For example, the actuator system 24 can change the state of the barrier 22 between the configurations. The design of the expandable barrier 22 can be varied pursuant to the teachings provided herein. In the non-exclusive implementation illustrated in FIGS. 2-5, the expandable barrier 22 forms an expandable chamber 22A that can be selectively expanded and retracted along an expansion axis 22B (e.g. parallel to the Z axis) by the actuation system 24. More specifically, in the implementation illustrated in FIGS. 2-5, the expandable barrier 22 includes a barrier hub 40, a first expansion region 42, a second expansion region 44, a first seal plate 46, a second seal plate 48, a first seal 50, and a second seal 52 that cooperate to form the expandable chamber 22A. Alternatively, for example, the expandable barrier 22 can be designed with a single expansion region.

In one non-exclusive embodiment, (i) the barrier hub 40 is rigid and annular ring shaped; (ii) the first expansion region 42 is flexible and annular tube shaped, e.g. flexible bellows; (iii) the second expansion region 44 is flexible and annular tube shaped, e.g. flexible bellows; (iv) the first seal plate 46 is circular disk shaped and includes an upper, annular shaped seal slot for receiving and retaining the first seal 50; (v) the second seal plate 48 is circular disk shaped and includes a lower, annular shaped, seal slot for receiving and retaining the second seal 52; and (vi) each seal 50, 52 is a “O” ring type seal. Moving from top to bottom along the expansion axis 22B, (i) the first seal 50 is inserted, coupled, and retained by the first seal plate 46; (ii) the first seal plate 46 is secured and coupled to a top of the first expansion region 42; (iii) a bottom of the first expansion region 42 is secured and coupled to a top of the barrier hub 40; (iv) a top of the second expansion region 44 is secured and coupled to a bottom of the barrier hub 40; (v) the second seal plate 48 is secured and coupled to a bottom of the second expansion region 44; and (vi) the second seal 52 is inserted, coupled and retained by the second seal plate 48.

With this design, the actuation system 24 can selectively expand and retract the expansion regions 42, 44 relative to the barrier hub 40 along the expansion axis 22B to selectively move the seals 50, 52 along the expansion axis 22B. Further, with this design, sealing is accomplished by the seals 50, 52 on both sides of the expansion regions 42, 44.

In one implementation, the barrier hub 40 can include a hub aperture 40A that extends transversely therethrough that allows for the actuation system 24 to selectively move the expandable barrier 22 between the configurations 28, 30, 32, 36.

As non-exclusive example, (i) the barrier hub 40, the expansion regions 42, 44, and the plates 46, 48 can be made of metal, plastic, composites, or other suitable materials; and (ii) the seals 50, 52 can be made of elastomers. Desired material characteristics for the seals 50, 52 include good sealing force retention; low compression set; low weight loss in vacuum (outgassing); low gas permeability, low adhesion to sealing (valve) surface 18, 20, and capable of being baked at a high temperature for example 200° C. With careful selection of (i) the material for the seals 50, 52, (ii) the design of the seal grooves that receive the seals 50, 52, and (iii) good manufacturing, the seals 50, 52 perform well (have a low leakage rate) even for ultra-high vacuum pressures. As a non-exclusive example, the valve 10 can have a leak rate of less than approximately 0.4×10⁻⁸ Pa·m³/s, when the difference between a first pressure in the first valve opening 18A, and a second pressure in the second valve opening 20A is at most 7.9×10⁻⁷ Pa.

The actuation system 24 selectively moves the expandable barrier 22 between the configurations 28, 30, 32, 36. The design of the actuation system 24 can be varied pursuant to the teachings provided herein. In one, non-exclusive example, the actuation system 24 can include (i) an actuator connector assembly 54; (ii) an expansion actuator system 56 (illustrated as a box in FIG. 1); and (iii) a transverse actuator system 58 (illustrated as a box in FIG. 1) that cooperate to move the expandable barrier 22.

The actuator connector assembly 54 fixedly connects and couples the expansion actuator system 56 and the transverse actuator system 58 to the expandable barrier 22. As a non-exclusive example, the actuator connector assembly 54 can include a connector tube 54A and a flexible tube seal 54B that seals the connector tube 54A to the valve body 14. In this implementation, the connector tube 54A is a rigid, hollow shaft that defines a tube passageway 54C, and includes (i) a distal end that fits into the hub aperture 40A and that is fixedly secured and coupled to the barrier hub 40; and (ii) a proximal end that is secured and coupled to the expansion actuator system 56 and the transverse actuator system 58. In this version, the connector tube 54A extends through a transverse aperture 141 in the second frame region 14E.

The flexible, tube seal 54B seals the connector tube 54A to the valve body 14, while allowing the connector tube 54A to be selectively moved along a transverse axis 58A (e.g. parallel to the X axis) that is transverse to the expansion axis 22B relative to the valve body 14. In one non-exclusive example, the tube seal can have a first seal end 54D that is fixedly secured to and sealed to the valve body 14, and a second seal end 54E that is fixedly secured to and sealed to the connector tube 54A. For example, the tube seal 54B can include a flexible bellows or another suitable seal.

The expansion actuator system 56 selectively moves (expands and contracts) the expandable barrier 22 along the expansion axis 22B. In one non-exclusive implementation, the expansion actuator system 56 includes one or more fluid pumps that selectively control the pressure of a barrier fluid 56A (illustrated with a few circles) in the expandable chamber 22A to selectively expand or contract the expandable chamber 22A. Stated in another fashion, the expansion actuator system 56 can be designed to (i) selectively direct the barrier fluid 56A into the barrier 22 to expand the barrier 22 (e.g. to the closed configuration 28) where the barrier engages the first valve surface 18 and the second valve surface 20, and (ii) selectively remove the barrier fluid 56A from the barrier 22 to retract the barrier 22 (e.g. to the open configuration 30). With this design, the expansion actuator system 56 changes the state of the barrier 22 between an expanded state (in the closed configuration 28) in which the barrier 22 engages the valve surfaces 18, 20; and a retracted state (in the open configuration 30) in which the barrier 22 does not engage the valve surfaces 18, 20. In this version, the expansion actuator system 56 is in fluid communication with the expandable chamber 22A via the tube passageway 54C in the connector tube 54A.

The transverse actuator system 58 selectively moves the expandable barrier 22 transversely along the transverse axis 58A within the valve body 14 when the barrier 22 is retracted (e.g. in the open configuration 30 and the withdrawn configuration 32). Stated in another fashion, the transverse actuator system 58 selectively moves the expandable barrier 22 transversely to the valve opening 18A, 20A, 34B between a first position in the open configuration 30 and a second position in the closed configuration 28. More specifically, the transverse actuator system 58 selectively moves the barrier 22 (when retracted) between (i) a first transverse position (illustrated in FIGS. 2 and 3) in which the barrier 22 is aligned with the first valve opening 18A and the second valve opening 20A, and the expansion axis 22B is aligned with the passageway axis 12C; and (ii) a second transverse position (illustrated in FIGS. 4 and 5) in which the barrier 22 is aligned with the intermediate valve opening 34B (and not the first valve opening 18A and the second valve opening 20A), and the expansion axis 22B is aligned with the intermediate axis 34D.

With this design, the transverse actuator system 59 can change the position of the barrier 22 between the first position and the second position, and the barrier 22 can be expandable at the second position. Stated in another fashion, the actuation system 24 selectively moves the barrier 22 between the first position and the second position in the retracted state, and the actuation system 24 changes the state of barrier 22 to the expanded state at the second position.

In one non-exclusive implementation, the transverse actuator system 58 can include one or more linear actuators and/or linear guides. In this version, the transverse actuator system 58 is physically connected to the expandable barrier 22 via the connector tube 54A.

The control system 26 is electrically connected to and selectively controls the actuation system 24, the intermediate pressure controller 34, and other components if necessary. The control system 26 may include, for example, a CPU (Central Processing Unit) 26A, and an electronic memory 26B. The control system 26 can be a central or distributed system.

The operation of the valve 10 can be best understood with initial reference to FIGS. 1 and 2. In FIG. 2, the expansion barrier 22 is expanded and in the closed configuration 28. The transverse actuator system 58 previously moved the expandable barrier 22 (when retracted) along the transverse axis 58A so that the expansion axis 22B is substantially aligned with the valve openings 18A, 20A and the passageway axis 12C. Further, the expansion actuator system 56 has filled and expanded the expandable barrier 22 (and expansion regions 42, 44) so that the first seal 50 is forcibly urged against (and engages) the first valve surface 18 to compress the first seal 50, and the second seal 52 is forcibly urged against (and engages) the second valve surface 20 to compress the second seal 52. In this design, sealing occurs by moving the seals 50, 52 laterally relative to the respective valve surfaces 18, 20.

In the closed configuration 28, (i) the first seal 50 seals and blocks the first valve opening 18A, and the first conduit 12A; and (ii) the second seal 52 seals and blocks the second valve opening 20A, and the second conduit 12B. With this design, in the closed configuration 28, (i) the first conduit 12A and the first valve opening 18A can be maintained at a first (conduit/opening) pressure, and (ii) the second conduit 12B and the second valve opening 20A can be maintained at a second (conduit/opening) pressure that is different from the first (conduit/opening) pressure. As a non-exclusive example, the first (conduit/opening) pressure can be at an ultra-high vacuum, and the second (conduit/opening) pressure can be at atmospheric pressure. As a result thereof, something in the second conduit 12B or connected to the second conduit 12B can be worked on or tested in an atmospheric environment, without subjecting whatever is connected to the first conduit 12 to these conditions.

As non-exclusive examples, the phase ultra-high vacuum shall mean and include 10⁻⁸, 10⁻⁷ or 10⁻⁶ pascals. The present invention is also applicable for high vacuum 10⁻³ to 10⁻⁵ Pascals and medium vacuum 10⁻¹ to 10⁻³ Pascals applications.

In an alternative example, the first (conduit/opening) pressure is a high pressure, and the second (conduit/opening) pressure can be at atmospheric pressure.

The amount of pressure required by the expansion actuator system 56 to fully seal the expandable barrier 22 will depend upon the design of the expandable barrier 22, characteristics of the elastomer seals 50, 52 and the vacuum pressure of the flow passage 12. As alternative, non-exclusive examples, the amount of pressure provided by the expansion actuator system 56 to the expandable barrier 22 can be approximately 200, 300, 350, or 400 kPa. However, pressures above and below these examples are possible.

In the optional embodiment with the intermediate pressure controller 34, when the expandable barrier 22 is in the closed configuration 28, the intermediate pressure source 34E can control an intermediate pressure in the body passageway 16 (as well as the intermediate conduit 34C and the intermediate valve opening 34B) to be somewhere between the first (conduit/opening) pressure and the second (conduit/opening) pressure. Stated in another fashion, in the closed configuration 28, the intermediate pressure source 34E can control the intermediate pressure in a volume between the seals 50, 52 to be different from the first (conduit/opening) pressure and the second (conduit/opening) pressure.

As a non-exclusive example, the first conduit pressure can be at an ultra-high vacuum, the second conduit pressure can be at atmospheric pressure, and the intermediate pressure is somewhere there between. As non-exclusive examples, the intermediate pressure can be (i) approximately half way between the first and second (conduit/opening) pressures; (ii) closer to the first (conduit/opening) pressure; or (iii) closer to the second (conduit/opening) pressure. For example, in the closed configuration 28, the intermediate pressure can be controlled to be greater than the first (conduit/opening) pressure and less than the second (conduit/opening) pressure.

With this design, because the intermediate pressure is between the (conduit/opening) pressures, (i) the first seal 50 has to only seal the difference between the first (conduit/opening) pressure and the intermediate pressure; and (ii) the second seal 52 has to only seal the difference between the second (conduit/opening) pressure and the intermediate pressure. As a result thereof, there will be less leakage when the valve 10 is in the closed configuration 28.

The movement of the valve 10 from the closed configuration 28 to the open configuration 30 can be best understood with reference to FIGS. 1-3. In FIG. 2, the expansion barrier 22 is expanded and in the closed configuration 28; while in FIG. 3, the expansion barrier 22 is retracted and in the open configuration 30. As provided herein, the expansion actuator system 56 can remove barrier fluid 56A from the barrier 22 to reduce the pressure (and possible can create a slight vacuum) in the expandable chamber 22A to move (retract) the expandable barrier 22 (and expansion regions 42, 44) along the expansion axis 22B from the closed configuration 28 to the open configuration 30. In the open configuration 30, (i) the first seal 50 is spaced apart from (and not engaging or contacting) the first valve surface 18; (ii) the second seal 52 is spaced apart from (and not engaging or contacting) the second valve surface 20; (iii) the valve opening 18A, 20A are both open; and (iv) the first conduit pressure and the second conduit pressure will be approximately the same.

The movement of the valve 10 from the open configuration 30 to the withdrawn configuration 32 can be best understood with reference to FIGS. 1, 3 and 4. In FIG. 3, the expansion barrier 22 is retracted and in the open configuration 30; while in FIG. 4, the expansion barrier 22 is still retracted and in the withdrawn configuration 32. As provided herein, with the expandable chamber 22A retracted along the expansion axis 22A, the transverse actuator system 58 can move the expandable chamber 22A along the transverse axis 58A until the expansion axis 22B is substantially aligned with the intermediate axis 34D. In the withdrawn configuration 32, the expansion barrier 22 is moved away from the passageway axis 12C and there is no blockage along the passageway axis 12C. Stated in another fashion, in the withdrawn configuration 32, the expansion barrier 22 is completely withdrawn from the path of the passageway axis 12C.

It should be noted that the transverse actuator system 58 should be controlled to move the barrier 22 transversely only when the barrier 22 is retracted and the seals 50, 52 are not engaging the valve body 14 to inhibit damage to the seals 50, 52. Stated in another fashion, the transverse actuator system 58 can be controlled to move the barrier 22 transversely when the barrier 22 is in the open configuration 30 and the withdrawn configuration 32.

The movement of the valve 10 from the withdrawn configuration 32 to the intermediate configuration 36 can be best understood with reference to FIGS. 1, 4 and 5. In FIG. 4, the expansion barrier 22 is retracted and in the withdrawn configuration 32; while in FIG. 5, the expansion barrier 22 is expanded and in the intermediate configuration 36. As provided herein, with the expandable chamber 22A retracted along the expansion axis 22A, the expansion actuator system 56 can move (expand) the expandable chamber 22A (e.g. the expansion regions 42, 44) along the expansion axis 22B (and the intermediate axis 34D) until the first seal 50 is forcibly urged against the intermediate valve surface 34A, and the second seal 52 is forcibly urged against the engagement surface 34F. In the intermediate configuration 36, the first seal 50 seals the intermediate valve opening 34B, and the intermediate conduit 34C. With this design, in the intermediate configuration 36, the first conduit 12A, the second conduit 12B and the body passageway 16 can be maintained at the same pressure, and the intermediate conduit 34C can be maintained at a different pressure.

It should be noted that the expandable barrier 22 can be sequentially moved (i) from the intermediate configuration 36 to the withdrawn configuration 32 by retracting the expandable barrier 22 along the expansion axis 22B with the expansion actuator system 56; (ii) from the withdrawn configuration 32 to the open configuration 30 by moving the expandable barrier 22 along the transverse axis 58A with the transverse actuator system 58; and (iii) from the open configuration 30 to the closed configuration 28 by expanding the expandable barrier 22 along the expansion axis 22B with the expansion actuator system 56.

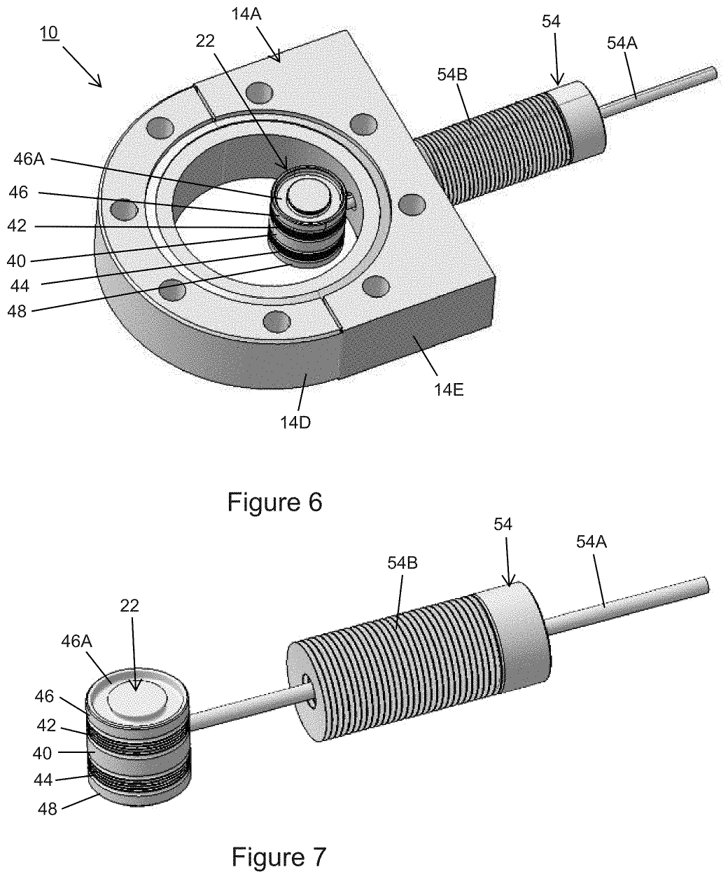

FIG. 6 is a simplified perspective view of a portion of the valve 10 of FIG. 1. More specifically, FIG. 6 illustrates (i) the valve frame 14A including the first frame region 14D and the second frame region 14E; (ii) a portion of the expandable barrier 22 including the barrier hub 40, the expansion regions 42, 44, and the seal plates 46, 48; and (iii) the actuator connector assembly 54 including the connector tube 54A and the tube seal 54B. It should be noted that the seals are not shown in FIG. 6. However, the seal groove 46A in the first seal plate 46 is visible.

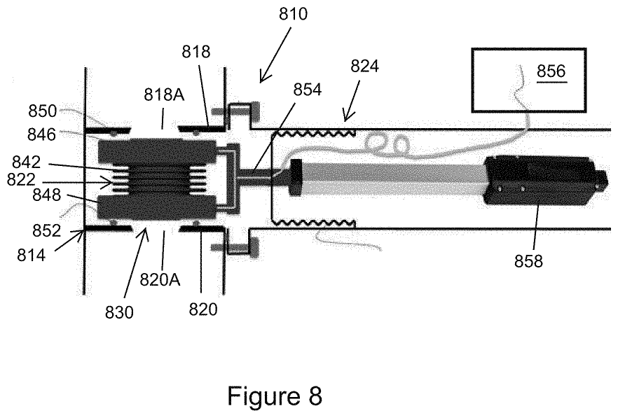

FIG. 7 is a simplified perspective view of (i) a portion of the expandable barrier 22 including the barrier hub 40, the expansion regions 42, 44, and the seal plates 46, 48; and (ii) the actuator connector assembly 54 including the connector tube 54A and the tube seal 54B. It should be noted that the seals are not shown in FIG. 7. However, the seal groove 46A in the first seal plate 46 is visible.

FIG. 8 is a simplified side illustration, in cut-away of another implementation of a valve 810. In this implementation, the valve 810 is somewhat similar to the corresponding valve 10 described above. In this implementation, the valve 810 includes (i) a valve body 814, (ii) a first valve surface 818 that defines a first valve opening 818A; (iii) a second valve surface 820 that defines a second valve opening 820A; (iv) an expandable barrier 822; and (v) an actuation system 824 that selectively moves the expandable barrier 822. In this implementation, the valve 810 is illustrated in the open configuration 830, and the valve 810 does not include the intermediate pressure controller.

Further, in FIG. 8, the expandable barrier 822 includes a single expansion region 842 that moves the two, spaced apart seal plates 846, 846. Further, in this implementation, the first seal 850 is secured to the first valve surface 818, and the second seal 852 is secured to the second valve surface 820. Alternatively, the first seal 850 can be secured to the first seal plate 846, and the second seal 852 can be secured to the second seal plate 846.

In FIG. 8, the actuator system 824 again includes the actuator connector assembly 854, the expansion actuator system 856, and the transverse actuator system 858 that are somewhat similar to the corresponding components described above.

As provided herein, the valve 10, 810 can be used as part of a number of different manufacturing, inspection, or processing assemblies.

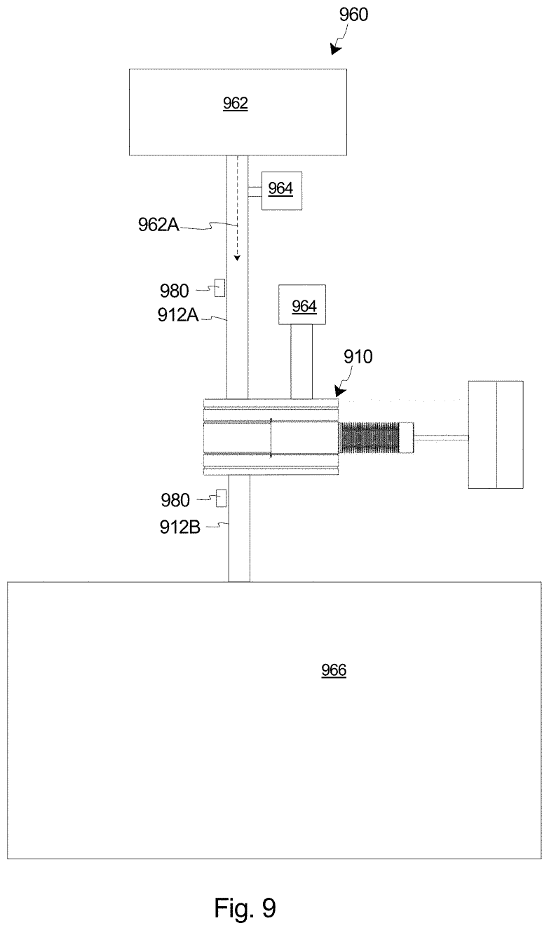

FIG. 9 is a simplified side view of an assembly 960 that includes a valve 910 having features described herein. In this non-exclusive implementation, the assembly 960 is an electron beam system (e.g. an electron beam column) that includes (i) an electron beam generator 962 that generates an electron beam 962A (illustrated with a dashed arrow), (ii) an environmental controller 964; and (iii) an auxiliary chamber 966. With this design, the valve 910 forms a portion of an electron beam column 960.

In this example, when the valve 910 is in the intermediate configuration (not shown in FIG. 9), (i) the environmental controller 964 can control the environment in the first conduit 912A, the valve 910, the second conduit 912B and the auxiliary chamber 966; and (ii) the electron beam generator 962 can direct the electron beam 962A through the first conduit 912A, the valve 910, the second conduit 9128, and into the auxiliary chamber 966 for processing whatever is in this chamber 966. For example, the environmental controller 964 can generate an ultra-high vacuum or other suitable environment.

Further, in this example, when the valve 910 is in the closed configuration (not shown in FIG. 9), (i) the environmental controller 964 can maintain and control the environment in the first conduit 912A and near the electron beam generator 962; (ii) the intermediate pressure controller 934 can control the pressure within the valve 910; and (ii) the auxiliary chamber 966 can be opened, with the contents inside subjected to atmospheric pressure to allow for maintenance or testing of the contents.

With this design, the controlled environment near the electron beam generator 962 is isolated and maintained by the valve 910.

It should be noted that the assembly 960 can include one or more beam steering elements 980 (two are illustrated with boxes) that can control and steer the electron beam 962A. For example, one or more of the beam steering elements 980 can include electromagnetic or electrostatic lenses, multipoles, deflectors, and/or other elements for controlling and/or steering the electron beam 962A. These components can be positioned inside or outside of the second conduits 912A, 9128. The conduits 912A, 912B are often referred to by those skilled in the art as flight tubes. It is well known that electron-optical components may be placed inside or outside a flight tube.

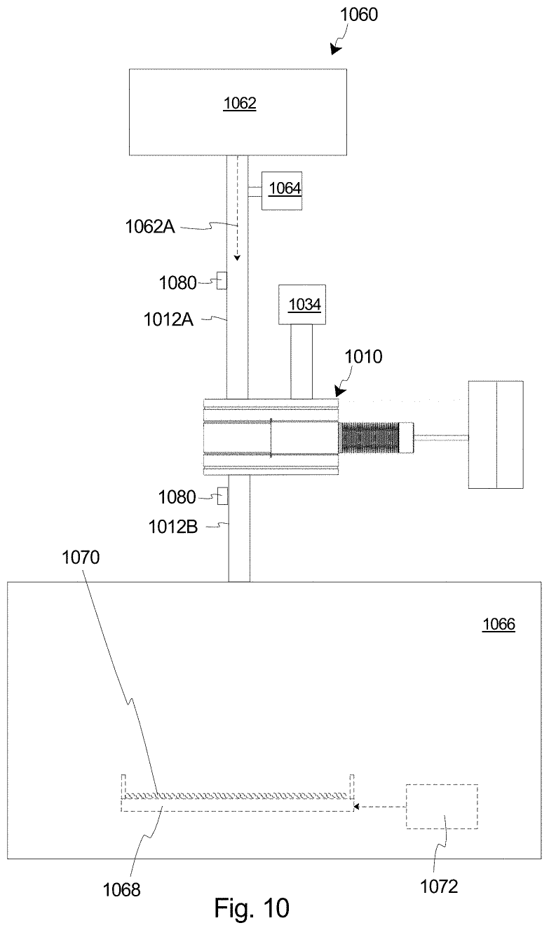

FIG. 10 is a simplified side view of another assembly 1060 that includes a valve 1010 having features described herein. In this non-exclusive implementation, the assembly 1060 is a metal, three dimensional additive manufacturing assembly (3D printer) that includes (i) an electron beam generator 1062 that generates an electron beam 1062A (illustrated with a dashed arrow), (ii) an environmental controller 1064; and (iii) an auxiliary chamber 1066 that are somewhat similar to the corresponding components described above and illustrated in FIG. 9.

However, in FIG. 10, a powder bed 1068 (illustrated in phantom) that retains a metal powder 1070 (illustrated with small circles), and a bed mover 1072 (illustrated in phantom) that selectively moves the powder bed 1068 are positioned within the auxiliary chamber 1066.

In this example, when the valve 1010 is in the intermediate configuration (not shown in FIG. 10), (i) the environmental controller 1064 can control the environment in the first conduit 1012A, the valve 1010, the second conduit 10128 and the auxiliary chamber 1066; and (ii) the electron beam generator 1062 can direct the electron beam 1062A through the first conduit 1012A, the valve 1010, the second conduit 10128, and into the auxiliary chamber 1066 to selectively melt (fuse) the powder 1070 to form a three dimensional object. For example, the environmental controller 1064 can generate an ultra-high vacuum or other suitable environment.

Further, in this example, when the valve 1010 is in the closed configuration (not shown in FIG. 10), (i) the environmental controller 1064 can maintain and control the environment in the first conduit 1012A and near the electron beam generator 1062; (ii) the intermediate pressure controller 1034 can control the pressure within the valve 1010; and (ii) the auxiliary chamber 1066 can be opened to measure, remove or further process the built object.

With this design, the controlled environment near the electron beam generator 1062 is isolated and maintained by the valve 1010.

The assembly 1060 can include one or more beam steering elements 1080 (two are illustrated with boxes) that can control and steer the electron beam 1062A. For example, one or more of the beam steering elements 1080 can include electromagnetic or electrostatic lenses, multipoles, deflectors, and/or other elements for controlling and/or steering the electron beam 1062A. These components can be positioned inside or outside of the second conduits 1012A, 1012B. It is well known that electron-optical components may be placed inside or outside a flight tube.

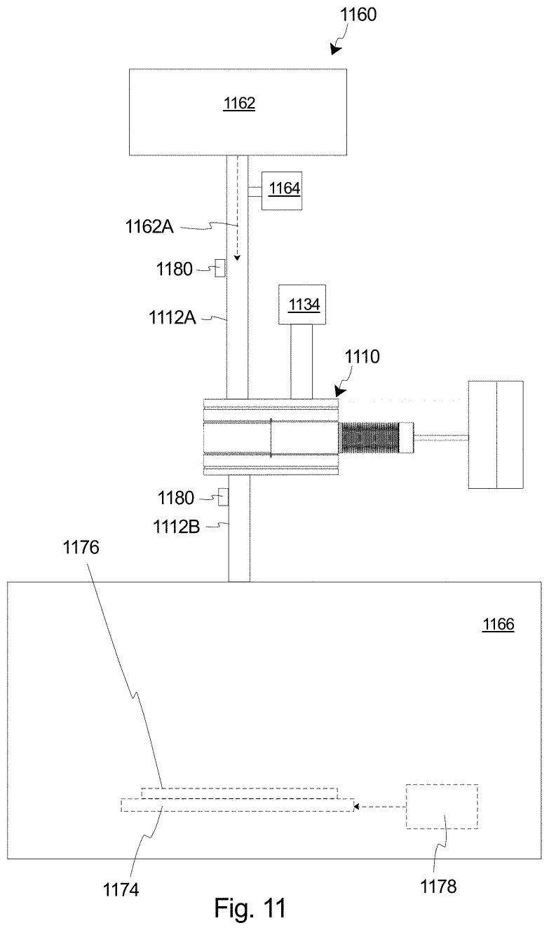

FIG. 11 is a simplified side view of another assembly 1160 that includes a valve 1110 having features described herein. In this non-exclusive implementation, the assembly 1160 is a lithography assembly that includes (i) an energy source 1162 that generates an energy beam 1162A (illustrated with a dashed arrow), (ii) an environmental controller 1164; and (iii) an auxiliary chamber 1166 that are somewhat similar to the corresponding components described above and illustrated in FIG. 10.

However, in FIG. 11, a wafer table 1174 (stage) (illustrated in phantom) that retains a wafer 1176 (illustrated in phantom) e.g. a semiconductor wafer, and a table mover 1178 (illustrated in phantom) that selectively moves the wafer table 1174 are positioned within the auxiliary chamber 1166.

In this example, when the valve 1110 is in the intermediate configuration (not shown in FIG. 11), (i) the environmental controller 1164 can control the environment in the first conduit 1112A, the valve 1110, the second conduit 11128 and the auxiliary chamber 1166; and (ii) the energy source 1162 can direct the energy beam 1162A through the first conduit 1112A, the valve 1110, the second conduit 11128, and into the auxiliary chamber 1166 to selectively form circuits on the wafer 1176. For example, the environmental controller 1164 can generate an ultra-high vacuum or other suitable environment.

Further, in this example, when the valve 1110 is in the closed configuration (not shown in FIG. 11), (i) the environmental controller 1164 can maintain and control the environment in the first conduit 1112A and near the energy source 1162; (ii) the intermediate pressure controller 1134 can control the pressure within the valve 1110; and (ii) the auxiliary chamber 1166 can be opened to measure, remove or further process the wafer 1176.

With this design, the controlled environment near the electron beam generator 1162 is isolated and maintained by the valve 1110.

The assembly 1160 can include one or more beam steering elements 1180 (two are illustrated with boxes) that can control and steer the energy beam 1162A, For example, one or more of the beam steering elements 1180 can include electromagnetic or electrostatic lenses, multipoles, deflectors, and/or other elements for controlling and/or steering the electron beam 1162A. These components can be positioned inside or outside of the second conduits 1112A, 1112B. It is well known that electron-optical components may be placed inside or outside a flight tube.

In one implementation, the energy source 1162 is an electron beam generator and the energy beam 1162A is an electron beam. As an alternative, non-exclusive implementation, the energy source 1162 is an extreme ultraviolet generator and the energy beam 1162A is an extreme ultraviolet beam,

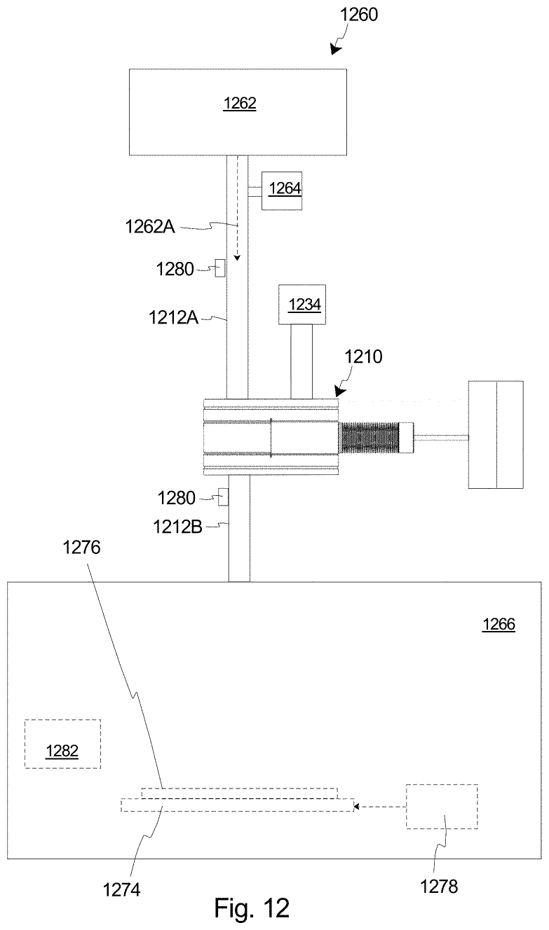

FIG. 12 is a simplified side view of another assembly 1260 that includes a valve 1210 having features described herein. In this non-exclusive implementation, the assembly 1260 is a scanning electron microscope that includes (i) an energy source 1262 that generates an energy beam 1262A (illustrated with a dashed arrow), (ii) an environmental controller 1264; and (iii) an auxiliary chamber 1266 that are somewhat similar to the corresponding components described above and illustrated in FIG. 10.

However, in FIG. 12, (i) a sample table 1274 (stage) (illustrated in phantom) that retains a sample 1276 (illustrated in phantom) that is being analyzed; (ii) a table mover 1278 (illustrated in phantom) that selectively moves the sample table 1274; and (iii) a detector 1282 (illustrated as a box in phantom) which are positioned within the auxiliary chamber 1266.

In this example, when the valve 1210 is in the intermediate configuration (not shown in FIG. 12), (i) the environmental controller 1264 can control the environment in the first conduit 1212A, the valve 1210, the second conduit 12128 and the auxiliary chamber 1266; and (ii) the energy source 1262 can direct the energy beam 1262A through the first conduit 1212A, the valve 1210, the second conduit 1212B, and into the auxiliary chamber 1266 to selectively form circuits on the wafer 1276. For example, the environmental controller 1264 can generate an ultra-high vacuum or other suitable environment.

Further, in this example, when the valve 1210 is in the closed configuration (not shown in FIG. 12), (i) the environmental controller 1264 can maintain and control the environment in the first conduit 1212A and near the energy source 1262; (ii) the intermediate pressure controller 1234 can control the pressure within the valve 1210; and (ii) the auxiliary chamber 1266 can be opened to measure, remove or further process the wafer 1276.

With this design, the controlled environment near the electron beam generator 1262 is isolated and maintained by the valve 1210.

The assembly 1260 can include one or more beam steering elements 1280 (two are illustrated with boxes) that can control and steer the energy beam 1262A. For example, one or more of the beam steering elements 1280 can include electromagnetic or electrostatic lenses, multipoles, deflectors, and/or other elements for controlling and/or steering the electron beam 1262A. These components can be positioned inside or outside of the second conduits 1212A, 1212B. It is well known that electron-optical components may be placed inside or outside a flight tube.

In one implementation, the energy source 1262 is an electron beam generator and the energy beam 1262A is an electron beam. A scanning electron microscope (SEM) is a type of electron microscope that directs the focused electron beam 1262A at the sample 1276 while the sample 1276 is being scanned (e.g. moved by the table mover 1278). Depending upon the material and geometry of the sample 1276, the electron beam 1262A will be reflected and/or scattered. The detector 1282 senses reflected and scattered electrons, which can be used to generate one or more images of the sample 1276.

The term “bellows” is used by extension for a flexible bag whose volume can be changed by compression or expansion, but not used to deliver air.

It is understood that although a number of different embodiments of the valve 10 have been illustrated and described herein, one or more features of any one embodiment can be combined with one or more features of one or more of the other embodiments, provided that such combination satisfies the intent of the present disclosure.

While a number of exemplary aspects and embodiments of the valve 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A valve comprising:
a valve body that defines a body passageway, the valve body includes a first valve surface that defines a first valve opening;
a barrier that is arranged in the body passageway, the barrier switches configurations between an open configuration in which the barrier does not engage the first valve surface; and a closed configuration in which the barrier engages the first valve surface and blocks the first valve opening; and
an actuation system that changes a state of the barrier between the configurations.

2. The valve of claim 1, wherein, the barrier is expandable so that the barrier engages the first valve surface at the closed configuration.

3. The valve of claim 2, wherein the actuation system includes an expansion actuator system that changes the state of the barrier between an expanded state and a retracted state.

4. The valve of claim 3, wherein the actuator system sets the state of barrier to the expanded state in the closed configuration so that the barrier engages the first valve surface and blocks the first valve opening.

5. The valve of claim 1, wherein the barrier is movable in the body passageway between a first position in the open configuration and a second position in the close configuration.

6. The valve of claim 5, wherein the actuation system includes a transverse actuator system that changes a position of the barrier between the first position and the second position.

7. The valve of claim 6, wherein the barrier is expandable at the second position.

8. The valve of claim 6, wherein the actuation system moves the barrier between the first position and the second position in the retracted state, and the actuation system changes the state of barrier to the expanded state at the second position.

9. A valve comprising:
a valve body that defines a body passageway, the valve body includes a first valve surface that defines a first valve opening;
an expandable barrier that is movable in the body passageway between an open configuration in which the barrier is retracted and does not engage the first valve surface; and a closed configuration in which the barrier is expanded, engages the first valve surface, and blocks the first valve opening; and
an actuation system that selectively moves the barrier between the configurations.

10. The valve of claim 9, wherein the barrier includes a first expansion region and a first seal that is coupled to the first expansion region; wherein in the open configuration, the first expansion region is retracted and the first seal is spaced apart from the first valve surface; and wherein in the closed configuration, the first expansion region is expanded and the first seal engages the first valve surface to block the first valve opening.

11. The valve of claim 9 further comprising: a second valve surface having a second valve opening; wherein in the open configuration, the barrier does not engage the second valve surface; and wherein in the closed configuration, the barrier engages the second valve surface and blocks the second valve opening.

12. The valve of claim 11, wherein the barrier includes a second expansion region and a second seal that is coupled to the second expansion region; wherein in the open configuration, the second expansion region is retracted and the second seal is spaced apart from the second valve surface; and wherein in the closed configuration, the second expansion region is expanded and the second seal engages the second valve surface to block the second valve opening.

13. The valve of claim 11, wherein when the barrier is in the closed configuration, the first valve opening is at a first pressure and the second valve opening is at a second pressure that is different from the first pressure.

14. The valve of claim 13, wherein when the barrier is in the closed configuration, a volume between the seals is at an intermediate pressure that is greater than the first pressure and less than the second pressure.

15. The valve of claim 9, wherein the actuation system includes (i) an expansion actuator system that selectively directs a barrier fluid into the barrier to move the barrier to either the closed configuration or the open configuration, and selectively removes the barrier fluid from the barrier to move the barrier to the other of the open configuration or the closed configuration; and (ii) a transverse actuator system that selectively moves the expandable barrier transversely to the first valve opening.

16. The valve of claim 15, wherein the transverse system selectively moves the expandable barrier between a first position in which the barrier is aligned with the first valve opening, and a second position in which the barrier is not aligned with the first valve opening.

17. An assembly that includes the valve of claim 9, and an environmental controller that controls the pressure in the first valve opening.

18. The assembly of claim 17 wherein the environmental controller controls the pressure in the first valve opening to be an ultra-high vacuum.

19. The assembly of claim 18 further comprising an electron beam source that selectively directs an electron beam through the valve.

20. The assembly of claim 19 wherein the valve forms a portion of an electron beam column.

21. The assembly of claim 19 further comprising a powder bed that retains a powder, and the electron beam melts at least a portion of the powder on the powder bed.

22. The assembly of claim 19 further comprising a stage that retains a semiconductor wafer, and the electron beam transfers an image to the semiconductor wafer.

23. A valve comprising:
a valve body that defines a body passageway, the valve body includes a first valve surface that defines a first valve opening, and a second valve surface that defines a second valve opening;
an expandable barrier that is movable in the body passageway between (i) a closed configuration in which the barrier is expanded, engages the first valve surface and second valve surface, and blocks the first valve opening and the second valve opening; (ii) an open configuration in which the barrier is retracted and does not engage the first valve surface and the second valve surface; and (iii) a withdrawn configuration in which the barrier is moved transversely away from the valve openings; and
an actuation system that selectively moves the barrier between the configurations.

24. The valve of claim 23, wherein the barrier includes a first expansion region and a first seal that is coupled to the first expansion region; wherein in the open configuration, the first expansion region is retracted and the first seal is spaced apart from the first valve surface; and wherein in the closed configuration, the first expansion region is expanded and the first seal engages the first valve surface to block the first valve opening.

25. The valve of claim 24 wherein the barrier includes a second expansion region and a second seal that is coupled to the second expansion region; wherein in the open configuration, the second expansion region is retracted and the second seal is spaced apart from the second valve surface; and wherein in the closed configuration, the second expansion region is expanded and the second seal engages the second valve surface to block the second valve opening.

26. The valve of claim 23, wherein when the barrier is in the closed configuration, the first valve opening is at a first pressure and the second valve opening is at a second pressure that is different from the first pressure.

27. The valve of claim 26, wherein when the barrier is in the closed configuration, a volume between the seals is at an intermediate pressure that is greater than the first pressure and less than the second pressure.

28. The valve of claim 23, wherein the actuation system includes (i) an expansion actuator system that selectively directs a barrier fluid into the barrier to move the barrier to either the closed configuration or the open configuration, and selectively removes the barrier fluid from the barrier to move the barrier to the other of the open configuration or the closed configuration; and (ii) a transverse actuator system that selectively moves the expandable barrier transversely to the first valve opening.

29. The valve of claim 28, wherein the transverse system selectively moves the expandable barrier between a first position in which the barrier is aligned with the first valve opening, and a second position in which the barrier is not aligned with the first valve opening.

30. An assembly that includes the valve of claim 23, and an environmental controller that controls the pressure in the first valve opening.

31. The assembly of claim 30 wherein the environmental controller controls the pressure in the first valve opening to be an ultra-high vacuum.

32. The assembly of claim 31 further comprising an electron beam source that selectively directs an electron beam through the valve, and the valve forms a portion of an electron beam column.

33. The assembly of claim 32 further comprising a powder bed that retains a powder, and the electron beam melts at least a portion of the powder on the powder bed.

34. The assembly of claim 32 further comprising a stage that retains a semiconductor wafer, and the electron beam transfers an image to the semiconductor wafer.

35. The assembly of claim 31 further comprising an extreme ultraviolet source that selectively directs an extreme ultraviolet beam through the valve.

36. The assembly of claim 35 further comprising a stage that retains a semiconductor wafer, and the extreme ultraviolet beam transfers an image to the semiconductor wafer.

37. The assembly of claim 31 further comprising an electron beam source that selectively directs an electron beam through the valve at a sample, and an imager that produces images of the sample.

38. A method for selectively opening and closing a flow passageway, the method comprising:
providing a valve body that defines a body passageway, the valve body including a first valve surface that defines a first valve opening that is in fluid communication with the flow passageway; and
selectively moving an expandable barrier in the body passageway between an open configuration in which the barrier is retracted and does not engage the first valve surface; and a closed configuration in which the barrier is expanded, engages the first valve surface, and blocks the first valve opening.
